(19) United States
(12) Patent Application Publication
(10) Pub. No.: US 2011/0223305 A1
(43) Pub. Date: Sep. 15, 2011

(54) ERGONOMIC FOOD SCOOP AND METHOD

(76) Inventor: Seymour Cohen, Boynton Beach, FL (US)

(21) Appl. No.: 13/016,747

(22) Filed: Jan. 28, 2011

Related U.S. Application Data
(60) Provisional application No. 61/313,520, filed on Mar. 12, 2010.

(51) Int. Cl. A23G 9/28; A23P 1/10

(52) U.S. Cl. 426/512; 425/276

(57) ABSTRACT

An ergonomic food scoop may comprise a scoop bowl, a hand grip and a wrist support. A support member may interconnect the bowl and the hand grip and may be oriented perpendicular to the hand grip. The wrist support may be oriented parallel to the hand grip. One or more hand grip connectors may connect the hand grip to the wrist support.

### RELATED APPLICATIONS

This application claims the benefit of U.S. Provisional Patent Application No. 61/313,520, filed on Mar. 12, 2010

### BACKGROUND OF THE INVENTION

The present invention generally relates to food serving equipment and more particularly to a device to scoop and serve food such as ice cream from a large container.

In a typical ice cream shop, a worker may be required to scoop serving portions of ice cream from a container and place these portions into a cone or cup for each of many individual customers. Repeated long term use of a conventional ice cream scoop by the worker may result in pain and injury. This may be the result of the worker using only muscles of his or her hand to perform these repeated scooping tasks.

It may be seen that there is a need for a system for serving ice cream that will permit a worker to use larger and stronger muscles and reduce the use of smaller and weaker hand and wrist muscles, thus reducing a risk of injuries and pain.

### SUMMARY OF THE INVENTION

In one aspect of the present invention, an ergonomic food scoop may comprise a scoop bowl and a hand grip. A support member may interconnect the bowl and the hand grip and may be oriented perpendicularly to the hand grip. A wrist support may be oriented parallel to the hand grip. One or more hand grip connectors may connect the hand grip to the wrist support.

In another aspect of the present invention, an ergonomic method for scooping ice cream may comprise the steps of: gripping a hand grip of an ice cream scoop so that fingers of a user are perpendicular to the hand grip; engaging a user's wrist with a wrist support of the ice cream scoop; and dislodging a portion of ice cream from a container by pushing or pulling the ice cream scoop in a direction perpendicular to an axis of the hand grip.

In still another aspect of the invention, an ergonomic method for scooping ice cream may comprise the steps of: pushing a bowl of a scoop into the ice-cream by pushing on a hand grip of the scoop; turning the hand grip right or left; and pulling out the desired amount of ice-cream. The steps of pushing and pulling are performed with muscles of a user's forearm, upper arm, shoulder and torso.

These and other features, aspects and advantages of the present invention will become better understood with reference to the following drawings, description and claims.

### BRIEF DESCRIPTION OF THE DRAWINGS

FIGS. 1-5 are perspective views of a food scoop in accordance with an embodiment of the invention;

FIGS. 6-9 are plan, elevation and end views of the scoop of FIGS. 1-5 in accordance with an embodiment of the invention;

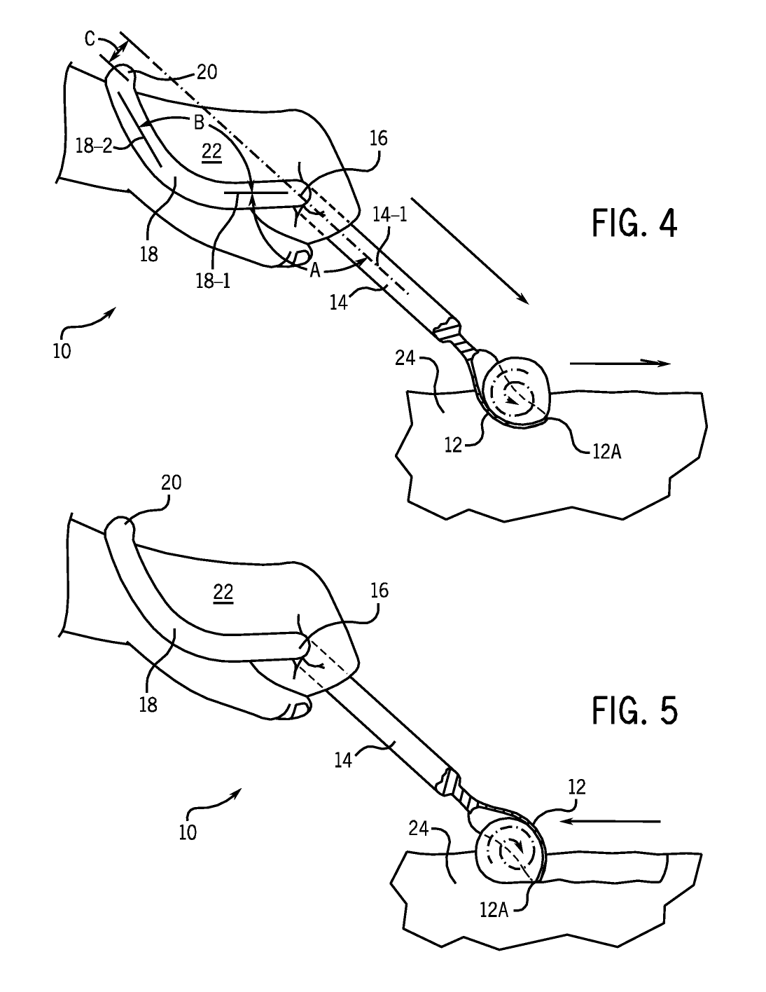

FIGS. 6A, 7A, 7B and 7C are sectional views of portions of the scoop of FIGS. 1-5; and

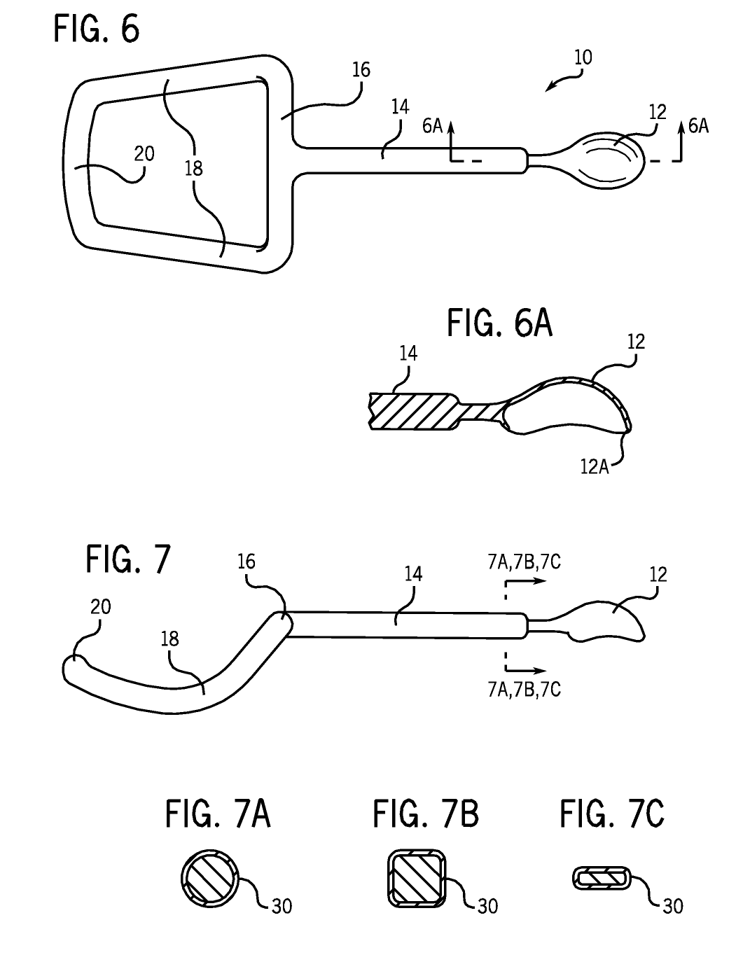

FIGS. 10 and 11 are plan and end views of an alternate embodiment of a food scoop in accordance with the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention generally provides a system for serving portions of food, such as ice cream, in which a worker may utilize arm and upper body muscles to perform the task of serving the ice cream.

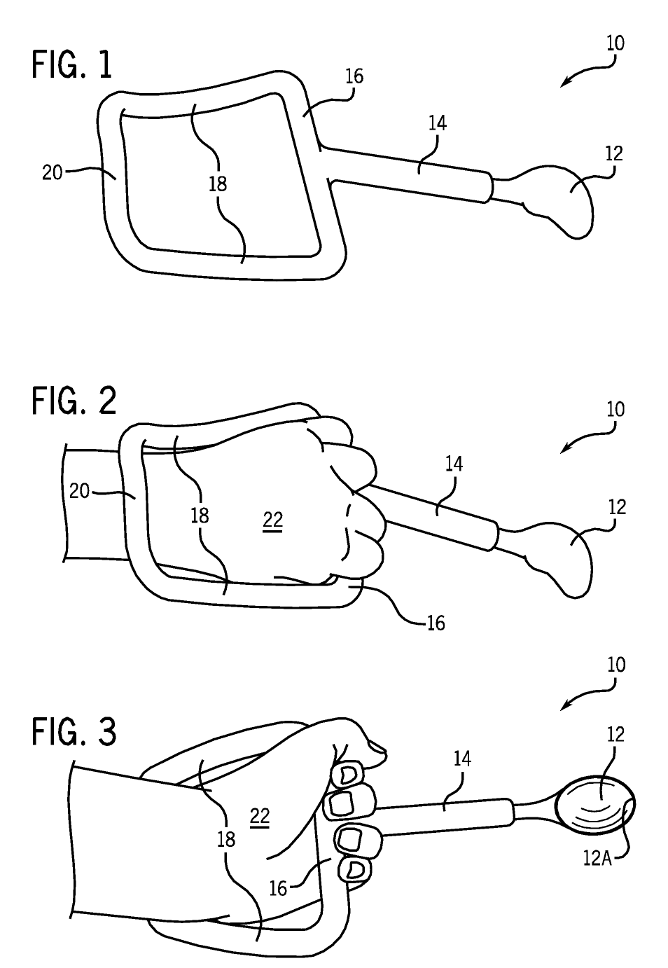

Referring now to the FIGS. 1 through 5, it may be seen that a food scoop or ice cream scoop 10 may comprise a scoop bowl 12, a support member 14, a hand grip 16, hand grip connectors 18 and a wrist support 20. The bowl 12 may be attached to the support member 14 either fixedly (as in FIG. 1) or removably (as in FIG. 11). The hand grip connectors 18 may have a curved configuration. The connectors 18 may be attached the hand grip 16 so that their axes 18-1 may be oriented at an angle A of about 135° to about 165° relative to an axis 14-1 of the support member 14. The connectors 18 may be configured so that their axes 18-2, at a connection with the wrist support 20, may be oriented at an angle B of about 150° to about 165° relative to the axes 18-1 of the connectors 18. The hand grip 16 may be positioned perpendicularly to the support member 14 and at an approximate midpoint between the bowl 12 and the wrist support 20. The wrist support 20 may be attached to the connectors 18 so that it its center is displaced from the axis 14-1 of the support member 14 by a distance C (as shown in FIG. 4). In an exemplary embodiment, the distance C may be about two inches. The hand grip 16 may be longer than the wrist support 20 so that the connectors 18 may not be parallel to one another but may instead converge toward one another as they pass from the hand grip 16 to the wrist support 20.

As seen if FIGS. 7A, 7B and 7C, the scoop 10 may be constructed with materials having various cross-sectional configuration. A coating 30 may be applied to the support member 14, the hand grip 16, the connectors 18 and the wrist support 20 to provide a non-slip texture and insulation. Additionally, the scoop 10 may be silver plated to inhibit bacterial growth.

The scoop 10 may be comfortably held buy a user 22 with his or her fingers perpendicular to and wrapped around the hand grip 16. The user's wrist positioned under the wrist support 20. The scoop 10 may be powered by muscles of the user's forearm, upper arm, shoulder and torso. The bowl 12 may be provided with sharpened edges 12A so that the user 22 may more easily penetrate hard ice-cream 24. The user 22 may push the bowl 12 into the hardened ice-cream 24, by pushing on the hand grip 16 and then pulling out the desired amount of ice-cream (as shown in FIGS. 4 and 5). Alternatively, the user 22 may turn the grip 16 right or left after the bowl 12 has been pushed into the ice cream 24 to dislodge a portion of the ice-cream 24 prior to pulling on the hand grip 16.

The support member 14 may be positioned relative to the bowl 12 and the hand grip 16 to promote greater pressure at a proximal portion of the bowl 12, with less effort. The hand grip 16 may be configured for ease of pushing, pulling and turning of the bowl 12. The connectors 18 may help secure the user's hand on the hand grip 16. The wrist support 20 may inhibit the user's wrist from turning up, thus reducing risk of injuries. The ice-cream scoop 10 may allow for the use of larger and stronger muscles of the user's forearm, upper arm, shoulder and torso, reducing the use of smaller and weaker hand and wrist muscles, thus reducing injuries and pain which may otherwise develop through long term use of conventional ice cream scoops.

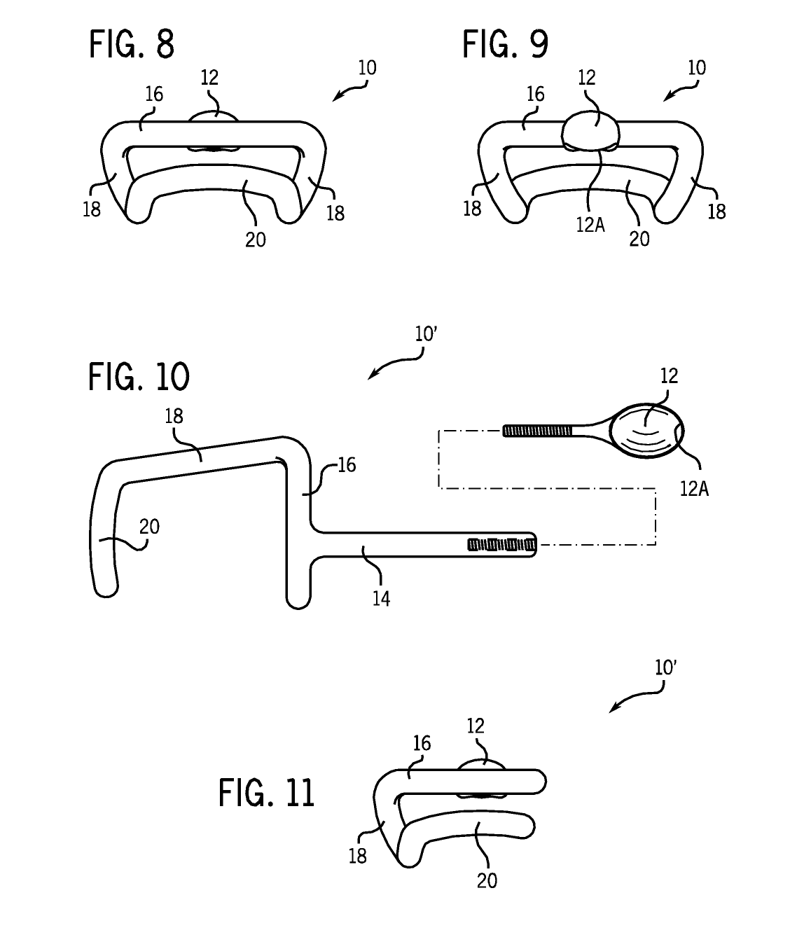

FIGS. 10 and 11 may illustrate an alternate embodiment of a scoop 10′ in which only one connector 18 may be utilized. This one-connector configuration may permit the user 22 to quickly pick up the scoop 10′ without passing his or her hand between two of the connectors 18.

It should be understood, of course, that the foregoing relates to exemplary embodiments of the invention and that modifications may be made without departing from the spirit and scope of the invention as set forth in the following claims.

We claim:

1. An ergonomic food scoop comprising:
a scoop bowl;
a hand grip;
a support member interconnecting the scoop bowl and the hand grip, the support member being oriented perpendicularly to the hand grip;
a wrist support oriented parallel to the hand grip; and
one or more hand grip connectors connecting the hand grip to the wrist support.

2. The food scoop of claim 1 comprising two of the hand grip connectors and wherein the two hand grip connectors are spaced apart a sufficient distance to accommodate a user's hand between the hand grip connectors.

3. The food scoop of claim 2:
wherein the hand grip is shorter than the wrist support, and
wherein the hand grip connectors converge toward one another as they pass from the hand grip to the wrist support.

4. The food scoop of claim 1 wherein the hand grip connectors have a curved configuration.

5. The food scoop of claim 1 wherein the hand grip connectors are attached the hand grip so that first axes of the hand grip connectors are oriented at an angle of about 150° to about 165° relative to an axis of the support member.

6. The food scoop of claim 1 wherein the hand grip connectors are configured so that second axes of the hand grip connectors, at a connection with the wrist support, are oriented at an angle of about 150° to about 165° relative to the first axes of the hand grip connectors.

7. The food scoop of claim 1 wherein the wrist support is attached to the hand grip connectors so that it its center is displaced from an axis of the support member by a distance of about 2 inches.

8. An ergonomic method for scooping ice cream comprising the steps of:
gripping a hand grip of an ice cream scoop so that fingers of a user are perpendicular to the hand grip;
engaging a user's wrist with a wrist support of the ice cream scoop; and
dislodging a portion of ice cream from a container by pushing or pulling the ice cream scoop in a direction perpendicular to an axis of the hand grip.

9. The method of claim 8 further comprising the step of:
engaging a user's hand with handgrip connectors; and
rotating the ice cream scoop to further dislodge the ice cream from the container.

10. An ergonomic method for scooping ice cream comprising the steps of:
pushing a bowl of a scoop into the ice-cream by pushing on a hand grip of the scoop;
turning the hand grip right or left; and
pulling out the desired amount of ice-cream,
wherein the steps of pushing and pulling are performed with muscles of a user's forearm, upper arm, shoulder and torso.
